(19) United States
(12) Patent Application Publication
(10) Pub. No.: US 2025/0130636 A1
(43) Pub. Date: Apr. 24, 2025

(54) METHODS, APPARATUSES AND COMPUTER PROGRAM PRODUCTS FOR GAZE-DRIVEN ADAPTIVE CONTENT GENERATION

(71) Applicant: Meta Platforms, Inc., Menlo Park, CA (US)

(72) Inventor: Mantas Zurauskas, Redmond, WA (US)

(21) Appl. No.: 18/923,609

(22) Filed: Oct. 22, 2024

Related U.S. Application Data
(60) Provisional application No. 63/592,323, filed on Oct. 23, 2023.

(51) Int. Cl. G06F 3/01; G06T 7/00; G06T 7/73

(52) U.S. Cl. CPC G06F 3/013; G06F 3/012; G06T 7/0012; G06T 7/73; G06F 2203/011; G06T 2207/10016; G06T 2207/20081; G06T 2207/30201

(57) ABSTRACT

Systems and methods are provided for generating adaptive content. The system may implement a machine learning model including training data pre-trained, or trained in real-time based on captured content or prestored content associated with gazes of users, pupil dilations, facial expressions, muscle movements, heart rates, or gaze dwell times of users determined previously or in real-time. The system may determine a gaze(s) of an eye of a user or facial features of a face associated with the user viewing, by a device, items of content in an environment. The system may include determining, based on the gaze(s) or facial features, a state(s) or interest(s) of the user. The system may determine, by implementing the machine learning model and based on the state(s) or interest(s) of the user, content to generate a modification of the items of content or to generate new content items associated with the items of content.

### CROSS-REFERENCE TO RELATED APPLICATIONS

This application claims priority to U.S. Provisional Application No. 63/592,323, filed Oct. 23, 2023, entitled “Gaze-Driven Adaptive Content Generation,” which is incorporated by reference herein in its entirety.

### TECHNOLOGICAL FIELD

Exemplary aspects of this disclosure may relate generally to methods, apparatuses and computer program products to utilize eye tracking, face tracking and/or determinations of a gaze(s) of users to generate content for provision to devices.

### BACKGROUND

Artificial reality (AR) is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer).

Many AR systems may include predetermined content to be presented to users. Predetermined content may limit user experience in virtual environments such as virtual worlds, games, or stores primarily due to predetermined content being inherent inflexible and predictable. When a virtual environment is designed with fixed content, users may be limited to engaging with only fixed content that has been pre-established, without the possibility of personalization or dynamic changes. This rigidity may stifle creativity of users and their desire to explore or interact with an environment in a unique manner, ultimately leading to decreased immersion and dissatisfaction of users. Moreover, the predictability of predetermined content may make an environment feel repetitive and dull over time, as users may be unable to encounter new experiences or challenges that keep them engaged.

### BRIEF SUMMARY

Various systems, methods, and devices are described for generating adaptive content in association with an online presence for AR systems and/or virtual reality (VR) systems, mixed reality (MR) systems. In some examples, the adaptive content may be any suitable content for enhancing user experience based on a perceived interest(s) of a user(s). Generated adaptive content may include personalization of a virtual environment(s) based on a user experience, creation of interactive platforms between users, programs, and/or the like, or any other suitable content.

The present disclosure may provide systems and methods for an adaptive content generation model in association with a level of interest of a user(s). In various examples, systems and methods may receive data indicating a level of interest with content displayed in an AR device. In this regard, gazes, pupil dilations, muscle movements and/or facial expressions of a user(s) may be determined in relation to displayed content to the user(s) to determine a level of interest via an eye tracking system and/or face tracking system. Based on the level of interest(s) and the observed gaze and facial expressions of users in response to content being displayed, virtual environments may be generated (e.g., new content) and/or adapted (e.g., modified content) via machine learning models that may adapt to interests or preferences of the user(s) in real-time.

In one example aspect of the present disclosure, a method is provided. The method may include implementing a machine learning model including training data pre-trained, or trained in real-time based on captured content or prestored content associated with one or more gazes of one or more users, one or more pupil dilations of the one or more users, facial expressions of the one or more users, muscle movements of the one or more users, one or more heart rates, or one or more gaze dwell times of the one or more users determined previously or in real time. The method may include determining at least one of a gaze of an eye of a user or one or more facial features of a face of the user associated with the user viewing, by an apparatus, one or more items of content in an environment. The method may include determining, based on the determined at least one gaze or the one or more facial features, at least one state of the user or at least one interest of the user. The method may further include determining, by implementing the machine learning model and based on the determined at least one state of the user or the at least one interest of the user, content to generate a modification of the one or more items of content or to generate one or more new content items associated with the one or more items of content.

In another example aspect of the present disclosure, an apparatus is provided. The apparatus may include one or more processors and a memory including computer program code instructions. The memory and computer program code instructions are configured to, with at least one of the processors, cause the apparatus to at least perform operations including implementing a machine learning model including training data pre-trained, or trained in real-time based on captured content or prestored content associated with one or more gazes of one or more users, one or more pupil dilations of the one or more users, facial expressions of the one or more users, muscle movements of the one or more users, one or more heart rates, or one or more gaze dwell times of the one or more users determined previously or in real time. The memory and computer program code are also configured to, with the processor(s), cause the apparatus to determine at least one of a gaze of an eye of a user or one or more facial features of a face of the user associated with the user viewing, by the apparatus, one or more items of content in an environment. The memory and computer program code are also configured to, with the processor(s), cause the apparatus to determine, based on the determined at least one gaze or the one or more facial features, at least one state of the user or at least one interest of the user. The memory and computer program code are also configured to, with the processor(s), cause the apparatus to determine, by implementing the machine learning model and based on the determined at least one state of the user or the at least one interest of the user, content to generate a modification of the one or more items of content or to generate one or more new content items associated with the one or more items of content.

In yet another example aspect of the present disclosure, a computer program product is provided. The computer program product may include at least one non-transitory computer-readable medium including computer-executable program code instructions stored therein. The computer-executable program code instructions may include program code instructions configured to implement a machine learning model including training data pre-trained, or trained in real-time based on captured content or prestored content associated with one or more gazes of one or more users, one or more pupil dilations of the one or more users, facial expressions of the one or more users, muscle movements of the one or more users, one or more heart rates, or one or more gaze dwell times of the one or more users determined previously or in real time. The computer program product may further include program code instructions configured to determine at least one of a gaze of an eye of a user or one or more facial features of a face of the user associated with the user viewing, by an apparatus, one or more items of content in an environment. The computer program product may further include program code instructions configured to determine, based on the determined at least one gaze or the one or more facial features, at least one state of the user or at least one interest of the user. The computer program product may further include program code instructions configured to determine, by implementing the machine learning model and based on the determined at least one state of the user or the at least one interest of the user, content to generate a modification of the one or more items of content or to generate one or more new content items associated with the one or more items of content.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 illustrates an example of an artificial reality system comprising a headset, in accordance with an example of the present disclosure.

FIG. 5 illustrates another artificial reality system comprising a headset, in accordance with an example of the present disclosure.

FIG. 6 is an illustrative side view of a user using an AR device, in accordance with an example of the present disclosure.

FIG. 7 is a flow diagram of an example method of adaptive content generation, in accordance with an example of the present disclosure.

FIG. 8 illustrates an example of a machine learning framework in accordance with one or more examples of the present disclosure.

FIG. 9 illustrates an example flowchart illustrating operations for generating adaptive content by one or more communication devices in accordance with an example of the present disclosure.

FIG. 10 illustrates another example flowchart illustrating operations for generating adaptive content by one or more communication devices in accordance with an example of the present disclosure.

FIG. 11 illustrates another example flowchart illustrating operations for generating adaptive content by one or more communication devices in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, a gaze(s), or gaze(s) of an eye of a user(s) may refer to the direction in which the eyes of a user(s) may be focused. This may include both the specific point that the eyes are looking at (e.g., a fixation point) and the movement of the eyes as they shift focus from one point to another point (e.g., saccades).

As referred to herein, a pupil dilation(s), or pupil dilation(s) of an eye(s) of a user(s) may refer to the variation in a size of a pupil(s), which may be the opening in the center of an iris of the eye(s) that may regulate the amount of light entering the eye(s).

It is to be understood that the methods and systems described herein are not limited to specific methods, specific components, or to particular implementations. It is also to be understood that the terminology used herein is for the purpose of describing particular examples only and is not intended to be limiting.

### Exemplary System Architecture

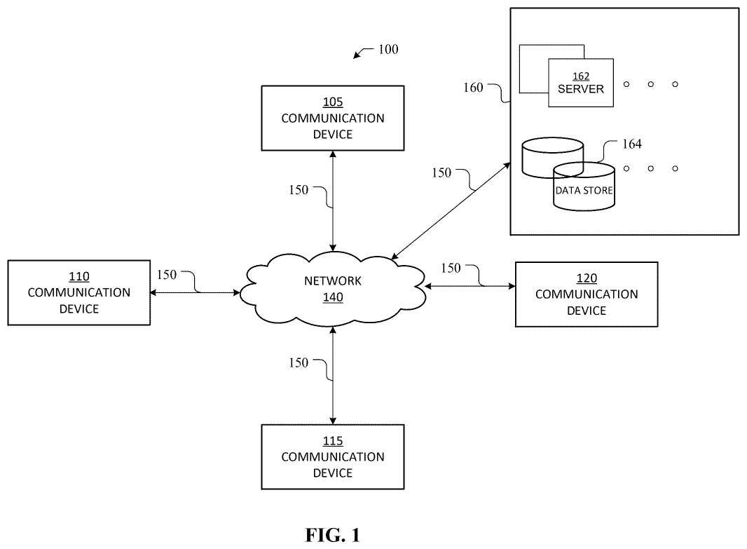

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

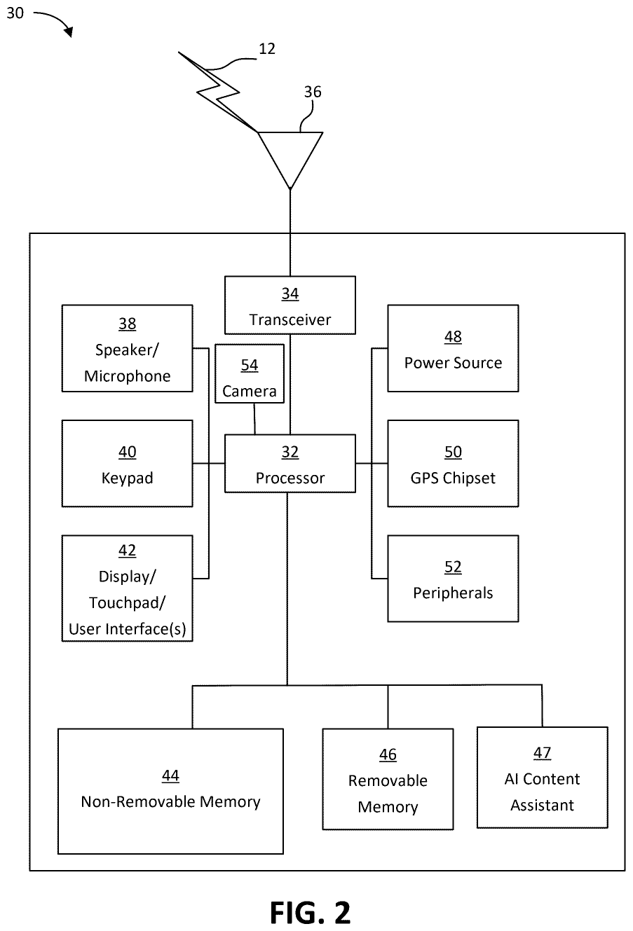

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

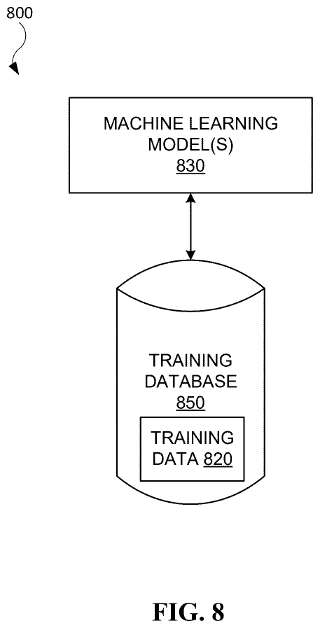

The UE 30 may further include an artificial intelligence (AI) content assistant 47 that may provide content generation based in part on determining at least one of a gaze of one more eyes of a user, facial expressions, facial features of a user(s) and/or the like, as described more fully below. In some examples, the AI content assistant 47 may implement a machine learning model (e.g., machine learning model(s) 830 of FIG. 8) and/or an AI model that may be pre-trained, trained in real-time, and/or periodically trained with training data (e.g., training data 820 of FIG. 8) to enable the provision of content generation based in part on determining at least one of a gaze of one more eyes of a user, facial expressions, facial features of a user(s) and/or the like, as described more fully below.

### Exemplary Computing System

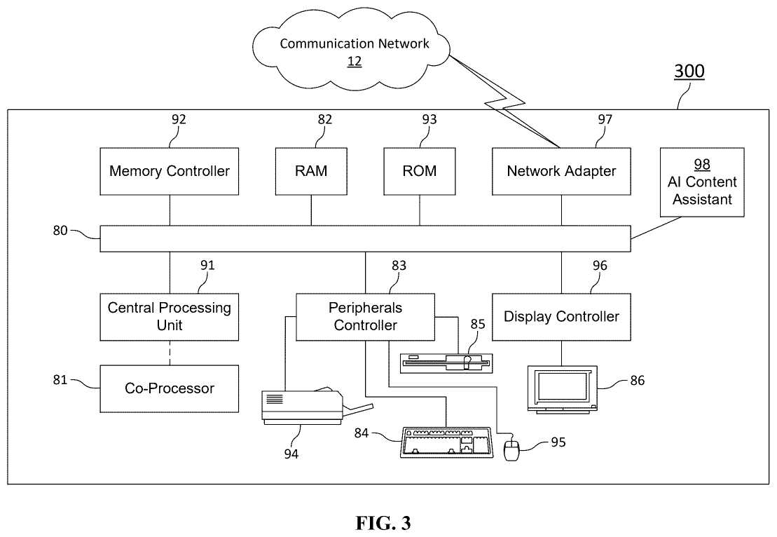

FIG. 3 is a block diagram of an exemplary computing system 300. In some exemplary embodiments, the network device 160 may be a computing system 300. The computing system 300 may include an AI content assistant 98. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

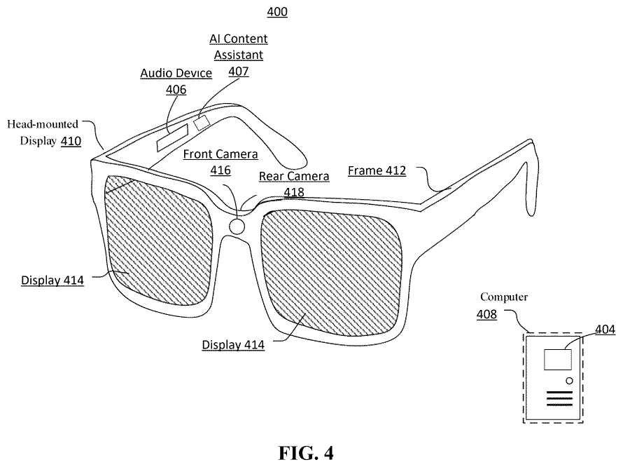

The AI content assistant 98 may receive one or more requests for content from a device (e.g., UE 30, artificial reality system 400, HMD 500 (e.g., via the AI content assistant 47 of FIG. 2, via the AI content assistant 407 of FIG. 4)). In response to receipt of such a request(s) from the device, the AI content assistant 98 may provide content (e.g., AR/VR/MR content) to adapt/modify the content being presented to a user of the device and/or may provide new content to present/provide to the user of the device. The content may be based on a determined emotion(s), current state(s), determined preference(s), and/or the like of the user of the device. In some examples, the AI content assistant 98 may implement a machine learning model (e.g., machine learning model(s) 830 of FIG. 8) and/or an AI model that may be pre-trained, trained in real-time, and/or periodically trained with training data (e.g., training data 820 of FIG. 8) to determine content generation based in part on receipt of the request(s) from the device.

### Exemplary Artificial Reality System

FIG. 4 illustrates an example artificial reality system 400. The artificial reality system 400 may include a head-mounted display (HMD) 410 (e.g., smart glasses and/or augmented/virtual reality device) comprising a frame 412, one or more displays 414, a computing device 408 (also referred to herein as computer 408), a controller 404, and an AI content assistant 407. In some examples, the HMD 410 may capture one or more items of text from one or more images/videos associated with a real world environment in the field of view of one or more cameras (e.g., cameras 416, 418) of the artificial reality system 400. The HMD 410 may utilize the captured text from the one or more images/videos to trigger one or more actions/functions by the artificial reality system 400. The displays 414 may be transparent or translucent allowing a user wearing the HMD 410 to look through the displays 414 to see the real world (e.g., real world environment) and displaying visual artificial reality content to the user at the same time. The HMD 410 may include an audio device 406 (e.g., speakers/microphones) that may provide audio artificial reality content to users. The HMD 410 may include one or more cameras 416, 418 which may capture images and/or videos of environments. In one exemplary embodiment, the HMD 410 may include a camera(s) 418 which may be a rear-facing camera tracking movement and/or gaze of a user's eyes.

One of the cameras 416 may be a forward-facing camera capturing images and/or videos of the environment that a user wearing the HMD 410 may view. The camera(s) 416 may also be referred to herein as a front camera(s) 416. The HMD 410 may include an eye tracking system to track the vergence movement of the user wearing the HMD 410. In one exemplary embodiment, the camera(s) 418 may be the eye tracking system. In some exemplary embodiments, the camera(s) 418 may be one camera configured to view at least one eye of a user to capture a glint image(s) (e.g., and/or glint signals). The camera(s) 418 may also be referred to herein as a rear camera(s) 418. The HMD 410 may include a face tracking system to track the muscle movements (e.g., subtle muscle movements) and/or facial expressions/features of the user wearing the HMD 410. In another example aspect of the present disclosure, the camera(s) 418 may be the face tracking system. The camera(s) of the face tracking system may capture one or more images, videos, or the like and/or associated audio content to track the muscle movements of the user and/or the facial expressions of the user wearing the HMD 410.

The eye tracking system within the HMD 410 may determine pupil dilation(s) by utilizing one or more cameras (e.g., camera(s) 418) and/or other sensors such as scanning systems aimed at an eye(s) of a user(s). The cameras may capture high-resolution images and/or videos of the eye(s) at frequent intervals. In some example aspects, the eye tracking system may utilize image processing applications or image processing algorithms to analyze the captured images and/or videos in real-time to facilitate determination of pupil dilation(s).

The process of the eye tracking system determining pupil dilation(s) may involve detecting the boundaries of a pupil(s) and the iris in each captured image(s)/video(s). By measuring the diameter of the pupil(s) or the area the pupil(s) occupies, the eye tracking system may determine the extent of pupil dilation. This measurement (e.g., of pupil dilation) may be performed in pixels and then may be converted into a physical unit based on calibration data specific to a camera setup of the cameras and the geometry of the eye(s) of a user and the gaze direction of the eye(s) of the user.

The HMD 410 may include a microphone of the audio device 406 to capture voice input from the user. The artificial reality system 400 may further include a controller 404 comprising a trackpad and one or more buttons. The controller 404 may receive inputs from users and relay the inputs to the computing device 408. The controller 404 may also provide haptic feedback to one or more users. The computing device 408 may be connected to the HMD 410 and the controller 404 through cables or wireless connections. The computing device 408 may control the HMD 410 and the controller 404 to provide the augmented reality content to and receive inputs from one or more users. In some example embodiments, the controller 404 may be a standalone controller or integrated within the HMD 410. The computing device 408 may be a standalone host computer device, an on-board computer device integrated with the HMD 410, a mobile device, or any other hardware platform capable of providing artificial reality content to and receiving inputs from users. In some exemplary embodiments, the HMD 410 may include an artificial reality system/virtual reality system.

The AI content assistant 407 (e.g., AI content assistant 407) may provide content generation based in part on determining at least one of a gaze(s) of one more eyes of a user, facial expressions, facial features of a user(s), muscle movements of a user, and/or the like, as described more fully below.

### Another Exemplary Artificial Reality System

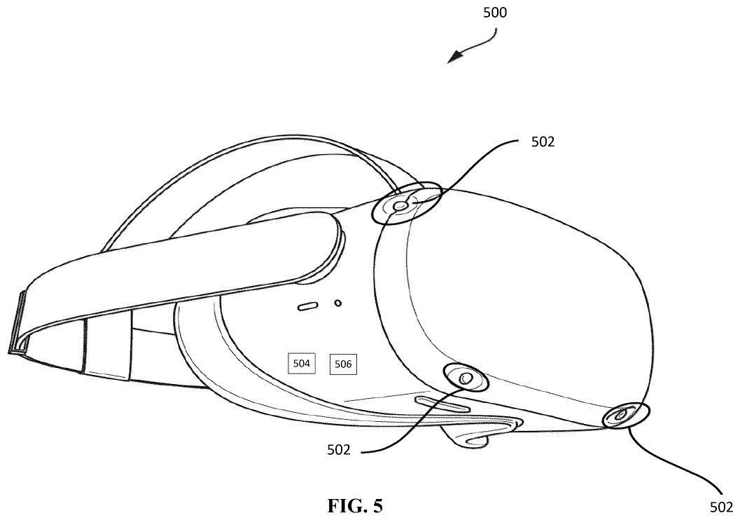

FIG. 5 illustrates another example of an artificial reality system including a head-mounted display (HMD) 500, image sensors 502 mounted to (e.g., extending from) HMD 500, according to at least one example aspect of the present disclosure. In some examples of the present disclosure, the artificial reality system 400 and/or HMD 410 may be an example of HMD 500. In some example aspects, image sensors 502 may be mounted on and protruding from a surface (e.g., a front surface, a corner surface, etc.) of HMD 500. In some exemplary aspects, HMD 500 may include an artificial reality system/virtual reality system. In an exemplary aspect, image sensors 502 may include, but are not limited to, one or more sensors (e.g., cameras 416, 418, a display 414, an audio device 406, etc.), a memory 506 (e.g., RAM, ROM) and a processor 504 (e.g., a controller (e.g., controller 504)). In exemplary embodiments, a compressible shock absorbing device may be mounted on image sensors 502. The shock absorbing device may be configured to substantially maintain the structural integrity of image sensors 502 in case an impact force is imparted on image sensors 502. In some exemplary embodiments, image sensors 502 may protrude from a surface (e.g., the front surface) of HMD 500 so as to increase a field of view of image sensors 502. In some examples, image sensors 502 may be pivotally and/or translationally mounted to HMD 500 to pivot image sensors 502 at a range of angles and/or to allow for translation in multiple directions, in response to an impact. For example, image sensors 402 may protrude from the front surface of HMD 500 so as to give image sensors 502 at least a 180 degree field of view of objects (e.g., a hand, a user, a surrounding real-world environment, etc.).

### Exemplary System Operation

Some example aspects of the present disclosure may provide systems and methods for generating adaptive content for a user(s) associated with a head-mounted display (e.g., HMD 410, HMD 500). In this regard, some example aspects of the present disclosure may provide adaptive content which may significantly enhance a user(s) experience by promoting personalization, interactivity, and endless possibilities. By providing virtual environments that incorporate dynamic content driven by user input and/or preferences, the exemplary aspects may facilitate a wide range of interests and needs of users, offering tailored experiences that resonate with each user. Furthermore, user-generated content (e.g., adaptive content) provided by the exemplary aspects may empower users to express their creativity and influence the virtual environment, fostering a sense of ownership and investment in a platform (e.g., a network (e.g., a social media network)). This increased immersion and engagement by users may lead to a richer, more fulfilling experience, driving user retention and promoting the growth and longevity of virtual environments.

Some example aspects of the present disclosure may utilize the inputs from various sensors of a device (e.g., an AR device) that captures the states of a user to utilize this captured information to drive/provide generative AI assistance and/or generative AI content creation mechanisms.

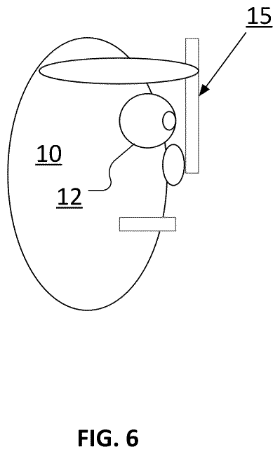

FIG. 6 is an illustrative side view of a user using an AR device, according to an example of the present disclosure. The user 10 may utilize an AR device 15 (e.g., artificial reality system 400, HMD 410, HMD 500, UE 30). Eye tracking, face tracking and gaze tracking technology of the AR device 15 may provide invaluable cues for personalizing experiences based on user interest, emotions, and/or other non-verbal cues by monitoring and interpreting a user's gaze and facial expressions/features. In some example aspects, one more cameras (e.g., camera 54, rear camera(s) 418) may provide the eye tracking, face tracking and gaze tracking of a user(s). By analyzing where a user's gaze is focused within a virtual environment(s) and/or a real-world environment(s), applications may gain insights into a user's interests and preferences. For example, in an instance in which a user consistently directs their attention towards specific content, such as a particular genre of games or a certain product category in a virtual store, the AR device (e.g., artificial reality system 400, HMD 410, HMD 500) may infer or determine the user's preferences and may tailor the experience of the user by presenting more content to the user that aligns with those interests associated with that user. In some examples, other streams of information or data may be used in coordination with eye tracking and face tracking technology to gain insight into a user's interests and preferences. Such streams may include, but are not limited to, heart rate monitoring from wrist wearable devices, or any suitable data streams, etc.

Additionally, in some example aspects, a heart rate of a user(s) may be determined based on data detected by the eye tracking system. For example, based on a video stream(s) (and/or images) detected by the eye tracking system (e.g., camera 54, rear camera 418), the eye tracking system may image the frames of the video stream(s) and may measure subtle changes of intensity of light that may be reflected from skin of the user(s). The eye tracking system may analyze one or more signals associated with the changes of intensity of light over a time period (e.g., a predetermined time period) which may be utilized by the eye tracking system to determine the heart rate(s) of the user.

The eye tracking system within the AR device may determine the heart rate(s) of a user by utilizing a technique known as remote photoplethysmography (rPPG). This method may involve capturing video streams of a user(s), specifically focusing on visible changes in pigmentation that may occur as blood pumps through the facial tissues of a user. These subtle changes in pigmentation may not be typically visible to the human eye but may be detected by high-resolution cameras (e.g., camera 54, rear camera(s) 418) with an AR device (e.g., AR device 15).

The process may operate based in part on video capture. The eye tracking system may utilize cameras (e.g., camera 54, rear camera 418) to continuously capture video streams of a face of a user. The eye tracking system may focus on regions with higher vascularization, such as the forehead or cheeks, where blood flow changes may be more pronounced.

Additionally, the process may involve signal extraction. For example, the captured video frames may be analyzed to extract color intensity values from the pigmentation regions. The eye tracking system may look for or analyze variations in the green channel of the red, green, and blue (RGB) color model, which has been determined to be responsive to changes in blood volume under skin of a user.

The eye tracking system may perform signal processing such that the extracted signals may be processed to filter out noise and unrelated color variations caused by movements or lighting changes. Techniques such as band-pass filtering may be utilized by the eye tracking system to isolate the frequency components that correspond to a typical human heart rate (e.g., between 0.5 hertz (Hz) and 4 Hz).

To perform the heart rate calculation/determination, by the eye tracking system, the processed signal may be analyzed to identify/determine peaks and troughs corresponding to heartbeats. The time interval between these peaks may be measured, and the heart rate(s) may be calculated/determined based on an average duration of these intervals over a predetermined time period.

The eye tracking system may perform data utilization such that the determined heart rate(s) may be utilized to infer/determine additional physiological and emotional states of the user. For example, sudden increases in heart rate may indicate excitement or stress, which may be beneficial data for adapting AR/VR/MR content to enhance user engagement or to manage user experiences during training simulations, gaming, or other activities (e.g., AR/VR/MR activities).

The determination of the heart rate(s) of the user may be utilized by the eye tracking system to determine the blood pressure of the user. For example, blood pressure may be indirectly estimated/determined from the heart rate measured by the eye tracking system through advanced methods such as Heart Rate Variability (HRV) analysis and Pulse Transit Time (PTT) performed by the AR device. These methods may be implemented (e.g., via a controller 404) by the AR device and may leverage fluctuations in heartbeats and the time it takes for a blood pulse(s) to travel between arterial sites, analyzed through facial recognition technologies. Machine learning models (e.g., machine learning model(s) 830) may integrate these data points along with user movement and historical health data to predict blood pressure, by the AR device, which may require initial calibration with measurements for accuracy.

Continuous monitoring and model adjustments by the AR device (e.g., via a controller 404) may help maintain the reliability of these non-invasive blood pressure estimations/determinations, which may be useful in virtual health assessments and/or wellness management. The eye tracking system by capturing the video stream(s) of the user may be capable of determining an activity that the user is performing in the video stream(s) based on the capture by the cameras (e.g., front camera 416) of the AR device that may capture content from a real-world environment. Based on analyzing and determining the activity, the eye tracking system may determine/measure a level(s) of excitement of the user while the user is performing an activity.

For example, the AR device may determine the activity being captured by utilizing integrated cameras (e.g., camera 54, camera(s) 418) to analyze a user's movements and interactions within both virtual environments and real-world environments. This analysis may involve recognizing specific gestures, postures, and actions using computer vision techniques and pattern recognition applications and/or algorithms. Once the activity is identified/determined, the AR device may assess the user's level of excitement based on physiological responses such as changes in heart rate(s), pupil dilation(s), and facial expressions/features, which may be continuously monitored by the eye tracking system and/or the face tracking system. These physiological signals, when correlated with the identified/determined activities, may enable the AR device to infer/determine the user's emotional state(s), such as for example excitement, by observing increases in physiological arousal associated with engaging or stimulating activities.

For example, the measured level may be a level of excitement in an instance in which the activity being analyzed is determined by the eye tracking system as an exercising activity that may be determined based on analyzing levels of the determined heart rate of the user. As such, the AI content assistant 407 may determine the heart rate to determine content (e.g., new content (e.g., exercise regimens) to provide the user and/or to adapt content currently presented to the user (e.g., increasing the intensity of a virtual trainer for training the user on the detected exercising activity). Accordingly, an AR device (e.g., AR device 15) of the example aspects of the present disclosure may determine one or more states (e.g., emotions, levels of interest with content, etc.) of a user(s) and may generate specifically tailored content to present/provide to the user (e.g., via display/touchpad/user interface(s) 42, display 414) based on the users state(s) and/or preferences of the user.

In some example aspects, the eye tracking system may determine pupil dilation(s) of one or more eyes (e.g., eye(s) 12) of a user (e.g., user 10) to determine an excitement level, or boredom level and other emotion levels of a user. The determined pupil dilation of an eye(s) of a user(s) may be utilized to infer/determine various emotion levels due to the physiological response of a pupil(s) to different emotional states. Pupil dilation(s) may be controlled by the autonomic nervous system, which may react involuntarily to emotional stimuli. For instance, when a user experiences excitement or interest, the pupil tends to dilate as part of the body's natural response to focus more on the subject of interest and gather more visual information.

Conversely, when a user is bored or fatigued, the pupil may contract. By continuously monitoring and analyzing changes in pupil size with high precision using eye tracking technology, the eye tracking system may detect subtle variations that correlate with specific emotional states. This data may then be processed using applications (e.g., machine learning model(s) 830) and/or algorithms that compare the observed pupil behavior against known patterns associated with different emotions. As a result, the eye tracking system may determine whether a user is happy, sad, frustrated, or experiencing other emotions based on how the pupil(s) of a user dilates or contracts in response to the content or situations presented in the AR environment. This understanding may allow for the adaptation of content in real-time to enhance user engagement or provide support, creating a more personalized and responsive user experience. In this regard, the pupil dilation(s) may provide clues, indications and/or determinations on a level of focus of the user. The AI content assistant 407 may determine based on the pupil dilation(s) content, an emotion (e.g., happy, sad, frustrated, etc.) of the user, an excitement of the user, fatigue of the user, boredom of the user, etc. and based on this pupil dilation(s) content may adapt the content being presented to the user by an AR device and/or may present additional content to the user.

As described above, in some examples, the AR device 15 may comprise a face tracking system. The face tracking system may interpret a user's emotional state by recognizing and decoding facial expressions/features (e.g., images/videos of faces) of a user captured by the face tracking system (e.g., camera 54, rear camera(s) 418). By detecting subtle changes in facial muscle movements of users, the face tracking system may identify emotions such as joy, sadness, surprise, frustration or other emotions. In some examples, the face tracking system may detect changes in facial movements of users by analyzing one or more images and/or videos captured by one or more cameras (e.g., camera 54, rear camera(s) 418) of the face tracking system. The AR device may also include and utilize one or more biometric sensors to measure physiological responses such as, for example, heart rate and skin conductance, which may provide further insights into an emotional state(s) of a user(s). Additionally, machine learning models (e.g., machine learning model(s) 830) may analyze voice tone and/or speech patterns captured by one or more microphones (e.g., speaker/microphone 38, audio device 406) of a device (e.g., UE 30, artificial reality system 400, AR device 15) to detect subtle cues of emotions such as, for example, stress, sadness, joy, frustration, happiness or other emotions, enhancing the device's ability to understand and react to a user's feelings comprehensively. Detecting these subtle changes in facial muscle movements may guide the AI content assistant 407 (e.g., AI content assistant 47) in creating/generating virtual environments (e.g., AR/VR/MR content) to respond to a user's determined emotional state(s) in real-time. This experience may lead to more empathetic and engaging experiences, as the AR device 15 may adapt the virtual environment to provide content that suits a user's current mood or alleviate their frustration for example based on determining one or more facial muscle movements of the user.

For example, in a virtual world, the AR device 15 may introduce content associated with calming visuals and audio in an instance in which the AR device 15 may detect signs of stress or offer a challenging game when the AR device 15 senses/detects boredom (e.g., based on determining facial muscle movement(s) of a user). By leveraging eye tracking and face tracking systems of the AR device 15, the AR device may enhance virtual environments and may create more personalized, immersive, and emotionally intelligent experiences that cater to the unique needs and preferences of each user (e.g., each user of a plurality of users of a system (e.g., system 100)).

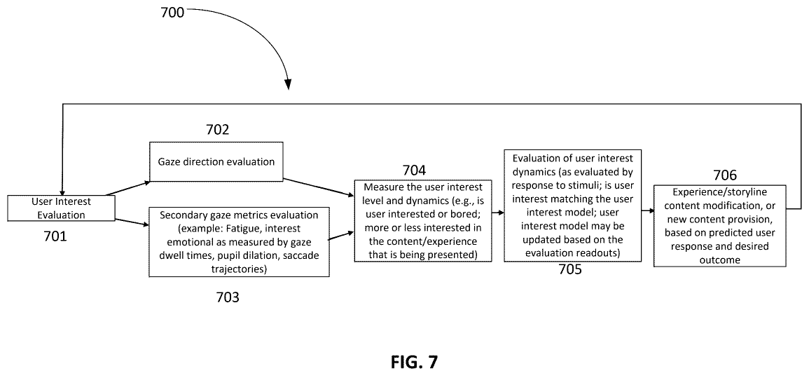

FIG. 7 is a flow diagram of an example method of adaptive content generation, according to an example of the present disclosure. At step 701 of the method 700, a device (e.g., AR device 15) may begin to assess user interest based on previous likes and/or other suitable data that may be stored in a memory of the AR device 15 or a data store (e.g., data store 164) associated with a network environment associated with a particular user or a user profile previously created and associated with a user (e.g., user 10). At step 702, a device (e.g., AR device 15) may determine the gaze of the user via the eye tracking system(s) (e.g., camera 54, rear camera 418) associated with the AR device 15. An example of the eye tracking system determining the gaze of a user may involve the eye tracking system using one or more cameras (e.g., camera 54, camera(s) 418) to continuously monitor and record the direction and focus points of an eye(s) of a user(s), and analyzing these data points to precisely identify where on a display, or in a field of view (FOV) of a device, or in a physical environment the user is looking at any given moment. At step 703, a device (AR device 15) may utilize the determined gaze of the user to evaluate many factors such as including, but not limited to, fatigue of a user(s), a level of interest of a user(s), emotion of a user(s) as measured based on determined gaze dwell times, pupil dilation(s), saccade trajectories, blinking rate, and/or the like.

Gaze dwell times may be determined by the eye tracking system of an AR device measuring the duration for which the user's gaze remains fixed on a specific point or area, which may be recorded in milliseconds or seconds. This metric may help in understanding the user's focus and interest in particular content or elements within an environment. Pupil dilation may be assessed by tracking changes in the diameter of the pupil in response to various stimuli, such as light exposure or emotional arousal, providing insights into the user's emotional state and cognitive processing. Saccade trajectories may involve analyzing the rapid, jerky movements of an eye(s) as the eye(s) moves from one point of interest to another, which may indicate how information is being processed and the sequence in which visual elements may be noticed. The blinking rate of an eye(s) may be monitored by counting the number of blinks over a time period, with variations in rate potentially indicating levels of fatigue or cognitive load. Together, these metrics may provide a comprehensive view of a user's psychological and physiological state. For instance, longer gaze dwell times and reduced blinking rates may suggest high engagement or deep concentration by a user, while frequent saccades and increased pupil dilation may indicate heightened emotional responses or cognitive strain.

These insights may be used not only to assess emotions, fatigue, and interest levels but also to evaluate cognitive load, attention span, and even stress levels. By understanding these factors, AR devices/systems and other interactive technologies may adapt dynamically to enhance user experience, personalize content delivery, and improve overall interaction efficiency. At step 704, a device (e.g., AR device 15) may determine a level of interest of a user(s) in an experience or content being displayed/presented (e.g., via the display/touchpad/user interface(s) 42, display 414) to the user to determine if the user (e.g., user 10) is interested, bored, or any increment between interested and bored in the experience or the content.

The AR device may determine the level of interest in the content being displayed to the user through a combination of eye tracking metrics and behavioral analysis. Specifically, the AR device may measure gaze dwell times to see how long the user focuses on particular elements of the content. Extended focus on specific areas may suggest higher interest. The AR device may also analyze saccade trajectories to understand the pattern(s) and speed of eye movements, which may help in identifying whether the user is scanning the content actively or just glancing over the content. Pupil dilation may be another beneficial metric. For instance, an increase in pupil size may indicate heightened interest or emotional engagement with the content. Additionally, the frequency and pattern of blinking may provide clues about the user's state of alertness and engagement. By synthesizing these data points, the AR device may utilize applications and/or algorithms to assess and quantify the user's interest level. At step 705, a device (e.g., AR device 15) may analyze the determined level of interest associated with the user to determine if the interest of the user matches a model (e.g., a user interest model) based on responses to particular stimuli associated with the content displayed (e.g., via the display/touchpad/user interface(s) 42, display 414) by the AR device.

Additionally, at step 705, the AR device may utilize a user interest model(s) that has been developed based on historical data and/or user interactions to predict and match the user's current interest levels. For example, suppose the user has previously shown a high level of engagement with interactive educational content that involves a lot of visual and auditory stimuli. In this scenario, as the user interacts with new content, the AR device may continuously measure the user's gaze dwell times, pupil dilation(s), and/or saccade patterns while engaging with similar educational applications or programs. In an instance in which the AR device detects that the user's current engagement metrics align closely with the high engagement patterns stored in the user interest model (e.g., long dwell times on educational graphics and consistent pupil dilation when new auditory information is presented), such may confirm that the content being displayed to the user matches the user's interests.

Conversely, in an instance in which the engagement metrics deviate significantly from the user interest model (e.g., shorter dwell times, rapid saccades away from the content), the AR device may infer/determine a mismatch and may then adjust the content dynamically. This dynamic adjustment may involve introducing more interactive elements similar to those that previously captivated the user's interest or switching to a different type of content that aligns better with the user's established interest profile. This process may ensure that the content remains engaging and relevant to the user, enhancing the overall interactive experience. In some examples, the user interest model may be updated based on the evaluation. In another example, the user interest model may be a component or constituent of a list of data associated with a user profile of a user. At step 706, a device (e.g., AR device 15) may adjust or modify the content being displayed to a user based on a predicted/determined user response and the desired outcome relative to the content being displayed.

At step 706, after analyzing the user's level of interest and comparing the user's level of interest with the user interest model, the AR device may predict that the user is losing interest in the current content due to signs such as for example decreased pupil dilation and shorter gaze dwell times. To re-engage the user, the AR device may dynamically adjust the content. For example, in an instance in which the user is interacting with a learning application, or a learning training program, about space and starts to show signs of disinterest, the AR device may introduce an interactive three-dimensional (3D) simulation of a planetary system, allowing the user to explore different planets by looking at the planets, thus making the experience more immersive and engaging. Alternatively, in an instance in which the content is a game and the user shows signs of frustration or boredom, the AR device may adjust the difficulty level of the game automatically or introduce new, more captivating game elements like bonus points or power-ups to maintain the user's interest. This adjustment may be based on the predicted user response and the desired outcome of keeping the user engaged and satisfied with the experience.

The method 700 may occur simultaneously or in a stepwise manner. The method 700 may also be iterative after step 706 returning back to step 701 for further assessment of the user's gaze(s). Although the method 700 may determine the gaze of the user, in some examples the method may be utilized for a face tracking system where a user's facial expressions/features may be assessed or evaluated to determine a level of interest in content being displayed/presented to the user. For example, the AR device 15 (e.g., via the AI content assistant 407) may adapt the content being displayed/presented to the user and/or may provide other content (e.g., AR content) to the user (e.g., via the display/touchpad/user interface(s) 42, display 414) for viewing/interaction by the user with the adapted content and/or other content based on the determined facial expressions of the user.

The AR device may utilize a face tracking system to analyze the user's facial expressions/features, which may provide additional insights into the user's emotional state and level of interest. The face tracking system may employ one or more cameras (e.g., camera 54, camera(s) 418) to capture real-time video of the user's face, and may utilize machine learning models (e.g., machine learning model(s) 830) to recognize and interpret various facial expressions such as smiles, frowns, or looks of surprise. For example, in an instance in which the user smiles or shows expressions of awe while interacting with a particular segment of AR content, the AR device may interpret these expressions as indicators of enjoyment or fascination. In response, the AR device may enhance the content being displayed to the user in similar themes or provide/present more complex, related topics to deepen the user's engagement.

Conversely, in an instance in which the user exhibits signs of confusion or frustration, such as furrowing brows or frowning, the AR device may recognize these expressions as signals of potential disinterest or difficulty in understanding the content. The face tracking system may then simplify the information, provide additional explanatory content, or switch to a different approach or topic, to present to the user, that may better capture the user's interest. The method 700 may also utilize both eye tracking and face tracking systems simultaneously to determine a level of interest of the user and predicted outcomes.

In some examples, the gaze evaluation of the AR device 15 may provide valuable cues for personalizing experiences based on user interest, emotions, or other non-verbal cues. By monitoring and interpreting the user's gaze, applications may gain insights into the user's interests and preferences, leading to more tailored user specific experiences. In some examples, the eye tracking system data may be utilized as input for machine learning algorithms/applications (e.g., machine learning model(s) 830) and user input to create customized content tailored to individual user preferences and needs associated with a user. In another example, generative AI may also use one or more gaze readout(s) to generate new and dynamic content that aligns with the user's interests and preferences, resulting in unique and personalized experiences for users of AR systems. By continuously learning from user interactions and refining the machine learning systems understanding of individual preferences, AI and/or generative AI may create highly personalized experiences that may evolve over time. These highly personalized experiences may make a user(s) feel valued and understood, fostering a deeper connection with a platform (e.g., system 100) or service, and may lead to increased user satisfaction and retention.

By using gaze readouts/gaze determinations from eye tracking systems, the AR device 15 may adapt virtual environments to present content (e.g., adapted AR content, new provisioned AR content) associated with a user's interests and preferences in real-time. For purposes of illustration and not of limitation, for example, in an instance in which the AR device (e.g., via the AI content assistant 407) determines based on a determined gaze(s) of a user that the user consistently directs their attention towards specific content within a virtual store or a game (e.g., a virtual/video game), the AR device may infer/determine preferences of the user and may tailor the user experience by presenting more content that aligns with the interests of the user (e.g., content associated with the virtual store or the game).

Consider an example in which the gaze of an eye(s) (e.g., eye(s) 12) of a user (e.g., user 10) may be determined by the eye tracking system and the gaze information may be provided to the AI content assistant 407 to determine one or more states of the user and associated measurements. In this regard, the user states and measurements may be utilized by the AI content assistant to adapt the content that the user is experiencing via an AR device (e.g., AR device 15). As such, for example, the content may be a video game where the intensity of that game is being modulated based on the user states and measurements determined based on the gaze information. In this example, in an instance in which the user states and/or measurements associated with the user, indicate or denote that the user is tired, the AI content assistant 407 may decrease the intensity of the video game. On the other hand, in an instance in which the user states and/or measurements associated with the user, indicate or denote that the user is alert, the AI content assistant 407 may increase the intensity of the video game to entice the user to be more engaged with the video game.

Consider another example in which the gaze of an eye(s) (e.g., eye(s) 12) of a user (e.g., user 10) may be determined by the eye tracking system and the gaze information may be provided to the AI content assistant 407 to determine one or more states of the user and associated measurements. In this example, the user states and measurements may be utilized by the AI content assistant 407 to adapt content and/or present new content associated with a learning experience/process being presented to the user via (e.g., by display/touchpad/user interface(s) 42, display 414) an AR device such as AR device 15. In an instance in which the user is interacting with a learning experience being presented to the AR device, for example the user may be learning a new skill by interacting with the learning experience, the eye tracking system may measure/determine how focused (e.g., alert) or how tired/fatigued the user is throughout the interactions with the learning experience based in part on determining a gaze of one or more eyes (e.g., eye 12) of the user. The measurements/determinations of the eye tracking system indicating how focused or tired the user may be may be provided by the eye tracking system to the AI content assistant 407 which may modulate the intensity of a training program associated with the learning experience.

As an example, consider that the learning experience may be a driver training program presented (e.g., via display/touchpad/user interface(s) 42, display 414) to the AR device in which the user aims to learn to drive. In an instance in which the AI content assistant 407 determines that the user is alert for example based on measurements of a gaze of an eye(s), the AI content assistant 407 may provide content to a virtual environment presented to the user by the AR device to simulate additional traffic lights in a scene of the virtual environment that the user may need to navigate virtually. On the other hand, in an instance in which the AI content assistant 407 determines that the user is fatigued, the AI content assistant 407 may provide content to the virtual environment presented to the user by the AR device to simulate less traffic lights in the scene.

A device(s) such as, for example, UE 30, AR device 15, the computing system 300, artificial reality system 400, or HMD 500 may generate a user interest model(s) associated with one or more users of a system (e.g., system 100). In this regard, the AI content assistant (e.g., AI content assistant 47, AI content assistant 407, AI content assistant 98) of the device(s) may measure/determine the activities that a user(s) has been prior engaged with or is currently engaged with and may determine a state(s) of a user(s) during the activities to generate user interest model(s) of the user(s). The user interest model(s) may be stored locally in a memory (e.g., non-removable memory 44, removable memory 46, RAM 82, ROM 93) of the device(s) and/or in a data store (e.g., data store 164) associated with the system and may serve as a predictive model for content provision to the user(s) associated with the user interest model(s).

As such, the AI content assistant (e.g., AI content assistant 47, AI content assistant 407, AI content assistant 98) may learn over time (e.g., a predetermined time period) a manner in which a user(s) may be responding to or interacting with different activities. This may help the AI content assistant to recommend the best possible content for the user(s), associated with the user interest model(s), in the future and to generate recommendations that may include providing appropriate options at the appropriate time(s)/situation(s) and also to predictably alter the experiences (e.g., adapt content and/or provide new content for an environment(s)) that the user(s) may be experiencing. For purposes of illustration, and not of limitation, for example the AI content assistant may analyze a user interest model(s), associated with a user(s), and may utilize the information of the user interest model(s) to change or update the applications (apps) that are being recommended for the user on a device(s) (e.g., UE 30, AR device 15, computing system 300, artificial reality system 400, HMD 500). As another example, the AI content assistant may utilize the user interest model(s) to change or update a type of music the user associated with the user interest model(s) may be listening to via a speaker (e.g., speaker/microphone 38, audio device 406) of the device(s)). As yet another example, the AI content assistant may utilize the user interest model(s) to change or update a predicted trajectory of a game (e.g., a virtual and/or video game), or a learning experience (e.g., a driver training program).

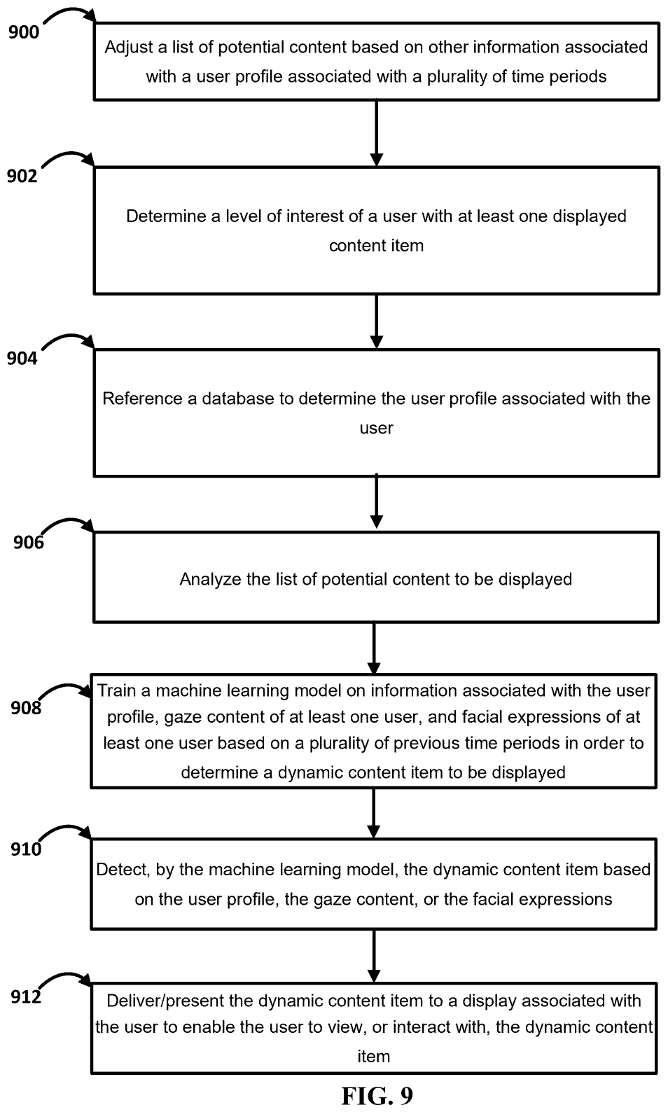

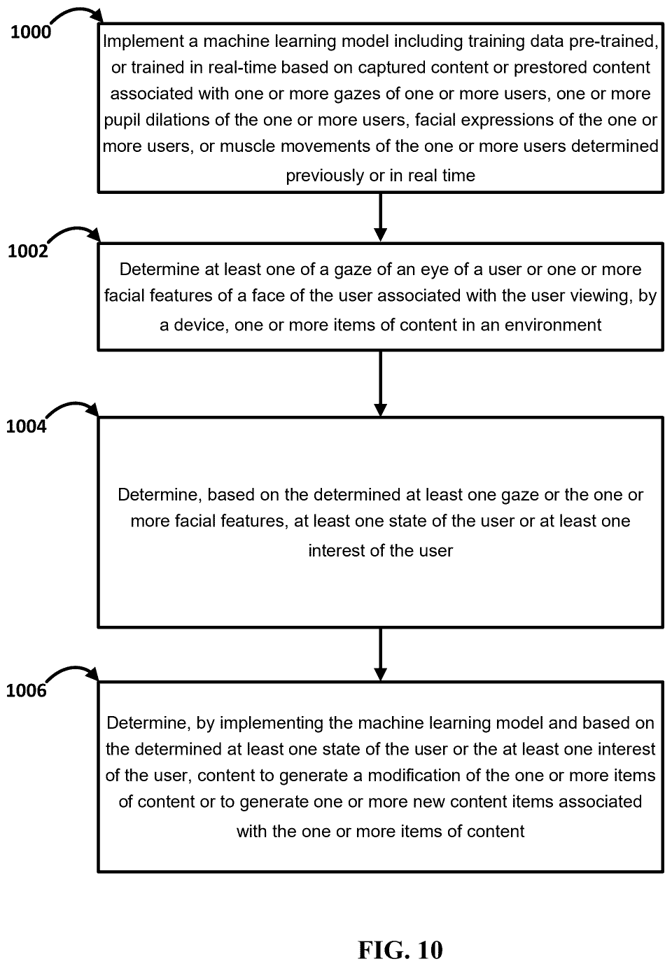

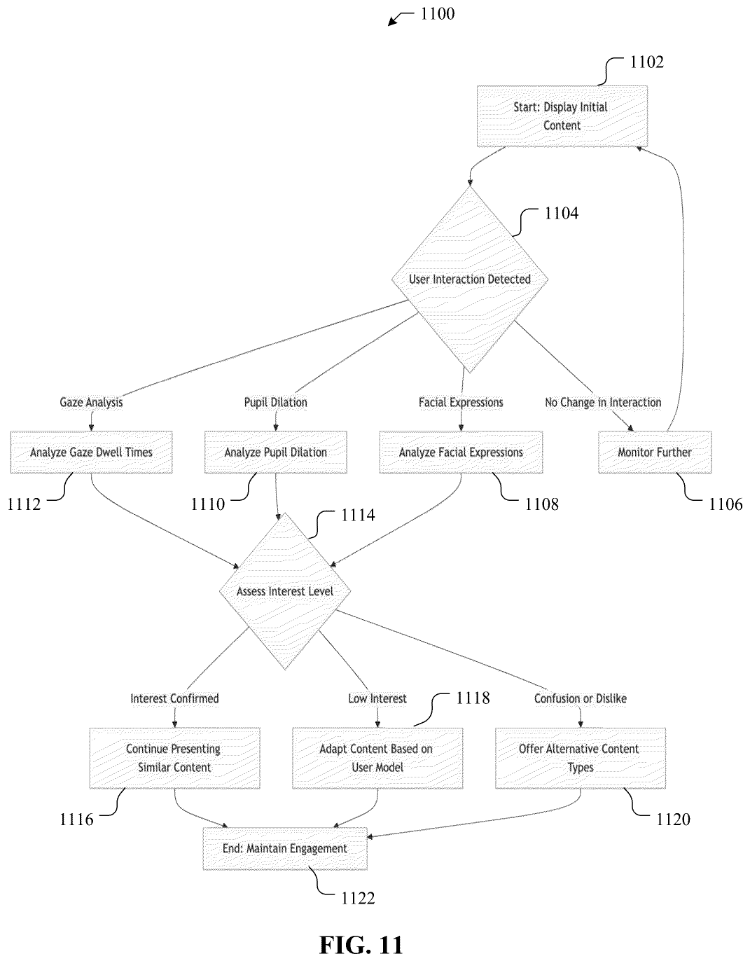

FIG. 8 illustrates an example of a machine learning framework 800 including machine learning model(s) 830 and a training database 850, in accordance with one or more examples of the present disclosure. The training database 850 may store training data 820. In some examples, the machine learning framework 800 may be hosted locally in a computing device or hosted remotely. By utilizing the training data 820 of the training database 850, the machine learning framework 800 may train the machine learning model(s) 830 to perform one or more functions, described herein, of the machine learning model(s) 830. In some examples, the machine learning model(s) 830 may be stored in a computing device. For example, the machine learning model(s) 830 may be embodied within a communication device (e.g., UE 30). In some other examples, the machine learning model(s) 830 may be embodied within another device (e.g., computing system 300, artificial reality system 400, AR device 15, HMD 500). Additionally, the machine learning model(s) 830 may be processed by one or more processors (e.g., processor 32 of FIG. 2, coprocessor 81 of FIG. 3, controller 404 of FIG. 4, controller 504 of FIG. 5). In some examples, the machine learning model(s) 830 may be associated with operations (or performing operations) of FIG. 7, FIG. 9, FIG. 10 and FIG. 11. In some other examples, the machine learning model(s) 830 may be associated with other operations. In some examples, the machine learning model(s) 830 may be an example of the AI content assistant 47, AI content assistant 407, and/or the AI content assistant 98.

The training data 820 employed by the machine learning model(s) 830 may be pre-trained, fixed or updated periodically. Alternatively, the training data 820 may be updated in real-time based upon the evaluations performed by the machine learning model(s) 830 in a non-training mode. This may be illustrated by the double-sided arrow connecting the machine learning model(s) 830 and stored training data 820 which may be stored in the training database 850. Some other examples of the training data 820 may include, but are not limited to, items of content determined as being associated with a network (e.g., the Internet, a social network, etc.), a platform (e.g., system 100) or the like.

For purposes of illustration and not of limitation, for example, the training data 820 may relate to attributes of objects. For example, the object(s) may be a facial expression(s), muscle movement(s), pupil dilations of one or more eyes of a user, and/or one or more gazes of an eye(s) of one or more users. Attributes may include, but are not limited, one or more time periods, orientations, positions of particular facial features, a gaze(s) (e.g., a rate(s) of change of a gaze(s)), facial muscles, etc. The training data 820 may be utilized to train the machine learning model(s) 830 to predict/determine one or more best recommendations of content (e.g., adapted content and/or new content) to present to a user(s) (e.g., via a user interface (e.g., display/touchpad/user interface(s) 42, display 414)) of a device. Additionally, as described above, the machine learning model(s) 830 may be trained at an initial stage, in real-time and/or trained periodically (e.g., updated periodically).

In some examples, the machine learning model(s) 830 may evaluate attributes of a user(s) by hardware (e.g., of the AR device 15, UE 30, computing system 300, artificial reality system 400, HMD 500, etc.). For example, one or more cameras (e.g., camera 416, camera 54) may sense and/or capture a gaze angle of an eye(s) of a user(s), a pupil dilation of an eye(s) of a user(s) a facial expression(s), such as for example a smile, a stare in a direction, other facial or eye movements, muscle movements of a user(s), which may be associated with the content being displayed to a user(s). The attributes of a captured gaze(s), a determined pupil dilation(s), muscle movements (e.g., facial muscle movements), and/or facial expressions of a face(s) of a user(s) may then be compared with respective attributes of stored training data 820 (e.g., prestored training gazes, pupil dilations, muscle movements, facial expressions, and/or the like). The likelihood of similarity between each of the obtained attributes (e.g., of the captured gaze(s), pupil dilation(s), muscle movements, and/or facial expression(s)) and the stored training data 820 (e.g., prestored training gazes, pupil dilations, muscle movements and facial expressions) may be provided a determined confidence score(s). In one exemplary aspect, in an instance in which the confidence score(s) equals or exceeds a predetermined threshold, the attribute(s) may be included in a user interest model(s), which may be associated with a user profile of a user(s). The user interest model(s) may be utilized by the machine learning model(s) 830 to generate or determine which content may be the best content to present to the user(s) at a particular time(s). In another example, a description may include a certain number of attributes which may exceed a predetermined threshold to share content with a user(s). The sensitivity of determination of user interest in content based on a determined gaze(s), pupil dilation(s), muscle movements (e.g., facial muscle movements), and/or facial expressions of a face(s) of a user(s) may be customized/tailored based upon the needs or interests of the particular user(s).

Additional examples of training data 820 used for machine learning model(s) 830 (e.g., in the context of AR devices and/or user interaction(s)) may include, but is not limited to, biometric data, environmental context data, and/or user interaction history. Biometric data may include, but is not limited to, heart rate(s), skin conductivity, blood pressure(s) and/or thermal imaging, which may provide insights into a user's physiological state and may be indicative of stress levels, excitement, or discomfort. Environmental context data may include, but is not limited to, ambient noise levels, lighting conditions, and/or nearby objects or people, which may help a device/system (e.g., AR device 15) understand external factors that may influence user behavior and preferences. User interaction history may include, but is not limited to, logging and analyzing past interactions of the user with a device (e.g., AR device 15), including preferred content types, interaction times, and/or response patterns to different stimuli. This data may be determined through various sensors and tracking technologies integrated in a device (e.g., AR device). For example, heart rate monitors, thermal cameras, and/or environmental sensors may sense and obtain real-time data as a user(s) interacts with the device. This data may then be preprocessed to extract relevant features and labeled appropriately before being provided to the training database 850.

FIG. 9 illustrates an example flowchart illustrating operations to generate adaptive content items for provision by one or more communication devices according to an example of the present disclosure. At operation 900, a device may adjust a list of potential content based on other information associated with a user profile associated with a plurality of time periods. At operation 902, a device may determine a level of interest of a user with at least one displayed content item. At operation 904, a device may reference a database to determine the user profile associated with the user.

At operation 906, a device may analyze the list of potential content to be displayed. At operation 908, a device may train a machine learning model on information associated with the user profile, gaze content of at least one user, and facial expressions of at least one user based on a plurality of previous time periods in order to determine a dynamic content item to be displayed. At operation 910, a device may detect, by the machine learning model, the dynamic content item based on the user profile, the gaze content, or the facial expressions. At operation 912, a device may deliver/present the dynamic content item to a display associated with the user to enable the user to view, or interact with, the dynamic content item.

FIG. 10 illustrates an example flowchart illustrating operations to generate adaptive content items for provision by one or more communication devices according to an example of the present disclosure. At operation 1000, a device (e.g., AR device 15) may implement a machine learning model (e.g., machine learning model(s) 830) including training data (e.g., training data 820) pre-trained, or trained in real-time based on captured content or prestored content associated with one or more gazes of one or more users, one or more pupil dilations of the one or more users, facial expressions of the one or more users, or muscle movements of the one or more users determined previously or in real-time.

At operation 1002, a device (e.g., AR device 15) may determine at least one of a gaze of an eye (e.g., eye 12) of a user (e.g., user 10) or one or more facial features of a face of the user associated with the user viewing, by the device, one or more items of content in an environment. At operation 1004, a device (e.g., AR device 15) may determine, based on the determined at least one gaze or the one or more facial features, at least one state of the user or at least one interest of the user. At operation 1006, a device (e.g., AR device 15) may determine, by implementing the machine learning model and based on the determined at least one state of the user or the at least one interest of the user, content to generate a modification of the one or more items of content or to generate one or more new content items associated with the one or more items of content.

FIG. 11 illustrates an example flowchart illustrating operations to facilitate generation of adaptive content items for provision by one or more communication devices according to an example of the present disclosure. The operations may be associated with a method 1100 being performed. At operation 1102, a device (e.g., AR device 15) may display initial content. At operation 1104, a device (e.g., AR device 15) may determine whether there is user interaction detected. The user interaction detection may be a detection of user interaction with the initial content being displayed. At operation 1106, a device (e.g., AR device 15) may monitor further for any changes in user interaction in an instance in which the device determines there is no change in user interaction with the initial content being displayed.

At operation 1108, in response to determining there is a user interaction detection, a device (e.g., AR device 15) may determine/analyze one or more facial expressions of a user associated with the user interaction of the initial content. At operation 1110, in response to determining there is a user interaction detection, a device (e.g., AR device 15) may determine/analyze one or more pupil dilations of a user associated with the user interaction of the initial content. At operation 1112, in response to determining there is a user interaction detection, a device (e.g., AR device 15) may determine/analyze one or more gaze dwell times of a user associated with the user interaction of the initial content. In some examples, the operations 1108, 1110, 1112 may be performed concurrently/simultaneously. In other examples, the operations 1108, 1110, 1112 may be performed separately and/or at different instances (e.g., different time periods)

At operation 1114, a device (e.g., AR device 15) may determine/assess an interest level(s) of the user interacting with the initial content based in part on the analyzed one or more facial expressions of the user in operation 1108, the analyzed one or more pupil dilations of the user in operation 1110 and/or the analyzed one or more gaze dwell times of the user in operation 1112.

At operation 1116, a device (e.g., AR device 15) may continue presenting similar content, that is similar to the initial content, to the user in response to determining that the user's interest is confirmed regarding the initial content. At operation 1118, a device (e.g., AR device 15) may adapt content based on a user interest model(s) to display the adapted content to the user in response to determining that the user's interest with the initial content is low (e.g., low interest). At operation 1120, a device (e.g., AR device 15) may provide/offer one or more alternative content types to display to the user in response to determining that the user may exhibit some confusion with the initial content and/or may dislike the initial content. In some examples, the operations 1116, 1118, 1120 may be performed concurrently/simultaneously. In other examples, the operations 1116, 1118, 1120 may be performed separately and/or at different instances (e.g., different time periods). At operation 1122, a device (e.g., AR device 15) may maintain engagement with the user and may end/stop the method 1100 in response to performing operations 1116, 1118, and/or 1120.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
implementing a machine learning model comprising training data pre-trained, or trained in real-time based on captured content or prestored content associated with one or more gazes of one or more users, one or more pupil dilations of the one or more users, facial expressions of the one or more users, muscle movements of the one or more users, one or more heart rates, or one or more gaze dwell times of the one or more users determined previously or in real time;
determining at least one of a gaze of an eye of a user or one or more facial features of a face of the user associated with the user viewing, by an apparatus, one or more items of content in an environment;
determining, based on the determined at least one gaze or the one or more facial features, at least one state of the user or at least one interest of the user; and
determining, by implementing the machine learning model and based on the determined at least one state of the user or the at least one interest of the user, content to generate a modification of the one or more items of content or to generate one or more new content items associated with the one or more items of content.

2. The method of claim 1, further comprising:
providing the modification of the one or more items of content or the one or more new content items to a display or a user interface of the apparatus to enable the user to interact with, or view, the modification of the one or more items of content or the one or more new content items.

3. The method of claim 1, wherein the apparatus comprises at least one of an artificial reality device, a head-mounted display, or smart glasses.

4. The method of claim 1, further comprising:
determining the at least one of the gaze or the one or more facial features based on one or more images, or one or more video items captured by one or more cameras of the apparatus.

5. The method of claim 4, wherein:
the one or more images or the one or more video items are associated with the user performing one or more activities within, or associated with, the environment.

6. The method of claim 1, wherein:
the at least one state comprises at least one of joy, sadness, alertness, fatigue, interest, disinterest of the user while the user is performing an activity within, or associated with, the environment.

7. The method of claim 1, further comprising:
determining that the one or more facial features comprises one or more muscle movements of the face of the user.

8. The method of claim 1, wherein the environment comprises a virtual reality environment or an augmented reality environment.

9. The method of claim 4, further comprising:
determining at least one heart rate of the user or at least one blood pressure of the user based on the one or more images or the one or more video items of the user performing one or more activities, and wherein the modification of the one or more items of content or the one or more new content items are based on the determined at least one heart or the at least one blood pressure.

10. An apparatus comprising:
one or more processors; and
at least one memory storing instructions, that when executed by the one or more processors, cause the apparatus to:
implement a machine learning model comprising training data pre-trained, or trained in real-time based on captured content or prestored content associated with one or more gazes of one or more users, one or more pupil dilations of the one or more users, facial expressions of the one or more users, muscle movements of the one or more users, one or more heart rates, or one or more gaze dwell times of the one or more users determined previously or in real time;
determine at least one of a gaze of an eye of a user or one or more facial features of a face of the user associated with the user viewing, by the apparatus, one or more items of content in an environment;
determine, based on the determined at least one gaze or the one or more facial features, at least one state of the user or at least one interest of the user; and
determine, by implementing the machine learning model and based on the determined at least one state of the user or the at least one interest of the user, content to generate a modification of the one or more items of content or to generate one or more new content items associated with the one or more items of content.

11. The apparatus of claim 10, wherein when the one or more processors execute the instructions, the apparatus is configured to:
provide the modification of the one or more items of content or the one or more new content items to a display or a user interface of the apparatus to enable the user to interact with, or view, the modification of the one or more items of content or the one or more new content items.

12. The apparatus of claim 10, wherein the apparatus comprises at least one of an artificial reality device, a head-mounted display, or smart glasses.

13. The apparatus of claim 10, wherein when the one or more processors execute the instructions, the apparatus is configured to:
determine the at least one of the gaze or the one or more facial features based on one or more images, or one or more video items captured by one or more cameras of the apparatus.

14. The apparatus of claim 13, wherein:
the one or more images or the one or more video items are associated with the user performing one or more activities within, or associated with, the environment.

15. The apparatus of claim 10, wherein:
the at least one state comprises at least one of joy, sadness, alertness, fatigue, interest, disinterest of the user while the user is performing an activity within, or associated with, the environment.

16. The apparatus of claim 10, wherein when the one or more processors execute the instructions, the apparatus is configured to:
determine that the one or more facial features comprises one or more muscle movements of the face of the user.

17. The apparatus of claim 10, wherein the environment comprises a virtual reality environment or an augmented reality environment.

18. The apparatus of claim 13, wherein when the one or more processors execute the instructions, the apparatus is configured to:
determine at least one heart rate of the user or at least one blood pressure of the user based on the one or more images or the one or more video items of the user performing one or more activities, and wherein the modification of the one or more items of content or the one or more new content items are based on the determined at least one heart or the at least one blood pressure.

19. A non-transitory computer-readable medium storing instructions that, when executed, cause:
implementing a machine learning model comprising training data pre-trained, or trained in real-time based on captured content or prestored content associated with one or more gazes of one or more users, one or more pupil dilations of the one or more users, facial expressions of the one or more users, muscle movements of the one or more users, one or more heart rates, or one or more gaze dwell times of the one or more users determined previously or in real time;
determining at least one of a gaze of an eye of a user or one or more facial features of a face of the user associated with the user viewing, by an apparatus, one or more items of content in an environment;
determining, based on the determined at least one gaze or the one or more facial features, at least one state of the user or at least one interest of the user; and
determining, by implementing the machine learning model and based on the determined at least one state of the user or the at least one interest of the user, content to generate a modification of the one or more items of content or to generate one or more new content items associated with the one or more items of content.

20. The computer-readable medium of claim 19, wherein the instructions, when executed, further cause:
providing the modification of the one or more items of content or the one or more new content items to a display or a user interface of the apparatus to enable the user to interact with, or view, the modification of the one or more items of content or the one or more new content items.
